(19) United States
(12) Patent Application Publication
(10) Pub. No.: US 2013/0110675 A1
(43) Pub. Date: May 2, 2013

(54) Marketplace for Composite Application and Data Solutions

(71) Applicant: Rene Bouw, Kirkland, WA (US)

(72) Inventor: Rene Bouw, Kirkland, WA (US)

(73) Assignee: Microsoft Corporation, Redmond, WA (US)

(21) Appl. No.: 13/285,006

(22) Filed: Oct. 31, 2011

(51) Int. Cl. G06Q 30/06

(52) U.S. Cl. 705/26.41; 705/26.8

(57) ABSTRACT

Embodiments of the invention provide a composite subscription service that combines one or more applications and one or more data sets into a single package. The applications and data sets in the package are treated as a single entity for the end-users. The end-user receives a single bill for the composite solution and may buy and cancel the composite solution without addressing the individual components. Publishers of the individual components define how the components may be used and how the components participate in the revenue sharing. Each component may receive a share of revenue based on usage events such as time, transactions, or resource usage. Publishers also define license agreement terms for each component. A composite end-user license agreement (EULA) is created for the composite subscription based upon the license terms for each component.

### BACKGROUND

Traditionally, software applications have been created by a developer and offered for sale to users directly from the developer or through retail outlets. With the development and expansion of the Internet, developers have been able to offer software applications for download by purchasers via on-line websites. Such websites are typically hosted by the application developer or a retail entity. Large software applications, such as business applications, may be hosted by the application developer so that the end-user does not have to maintain and update the application. The evolution of cloud computing has resulted in more and more hosted applications being offered to users on a subscription basis.

Users have also been able to access data sets of information that has been compiled by various data publishers. Access to such data sets has traditionally been through the publisher alone. However, websites have begun to offer access to data sets from a plurality of publishers.

Users subscribe on a case-by-case basis to applications and/or data sets. The users enter into a purchase or subscription agreement for each application or data set individually. Additionally, each user must adopt the end user license agreement (EULA) for each application or data set separately.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments are disclosed for dealing with the monetization of composite solutions that include components, application modules and datasets, which are provided by different publishers or developers. Monetization as used herein refers to the conversion of application and data set usage information into charges to users/subscribers and payouts to the publishers/developers. The invention and embodiments described herein provide a foundation for a system that enables the provisioning of the composite solutions through a composition model, events and billing model.

Embodiments of the invention dramatically simplify the end-user experience for composite application and data sets. The user receives a single bill for the composite solution without regard to the number of applications and data sets comprising the composite solution. The user may buy and cancel the composite solution as a whole, without any partial buy/cancellation complexities. When the purchases or cancels a subscription to a composite solution, all of the component applications and data sets are treated as one as far as the user is concerned.

Embodiments of the invention enable the implementation of complex collaboration scenarios between publishers of application and data. Billable and usage events are collected from every single component of the solution automatically. The collected events drive billing charges to the subscriber as well as payout distributions among the group of publishers collaborating in the solution.

Each publisher may describe how its components will be available and how the publisher wants to participate in revenue sharing, which may be based on usage events, time (e.g. a monthly subscription), actual transactions, or metered resource usage.

In some embodiments, a composite end-user license agreement (EULA) may be provided with the composite solution. Each publisher may designate required or desired content to be included in a composite EULA. In this way, each publisher may indicate the EULA terms that are relevant for its part of the solution. Using the input from all of the publishers, a single composite EULA will be presented to the user.

The composite solution model describes the interaction between the components, the expected usage events, resources to be metered and a billing model for calculation of the end user charges as well as the payout distribution to the publishers.

Embodiments of the invention allow for authentication and authorization of the user for the composite solution in its entirety at the “entry point” of the solution. The user does not have to maintain authorization or authentication information for each individual module or dataset.

The composite solution model allows developers to provision subscriptions, billing model, usage events, application configurations, and automatic payout. In one embodiment, the solution uses the following components:

An access service capable of authorizing and authenticating users. The OAuth protocol may be utilized for this authorization and authentication. The user tokens contain composite claims for each of the individual pieces of the solution.

A metering service that is capable of collecting detailed events and resource usage from the components.

A billing and payout service that uses inputs from the metering service and the billing model to calculate usage charges for the user, as well as payouts to the publishers.

A provisioning service that is capable of configuring the above services and configuring a runtime for the components of the solution as well as the data access of the data sources based on the composite solution model.

### DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram illustrating a marketplace that offers data sets and applications to users according to one embodiment;

FIG. 2 is a block diagram illustrating relationships among entities associated with a packaged subscription in an application and data set marketplace;

FIG. 3 is a flowchart illustrating one embodiment of a process or method for offering composite application and data subscriptions to end-users;

FIG. 4 is a flowchart illustrating one embodiment of a process or method for using a composite application and data subscriptions by an end-user; and

FIG. 5 illustrates one embodiment of a suitable computing and networking environment.

### DETAILED DESCRIPTION

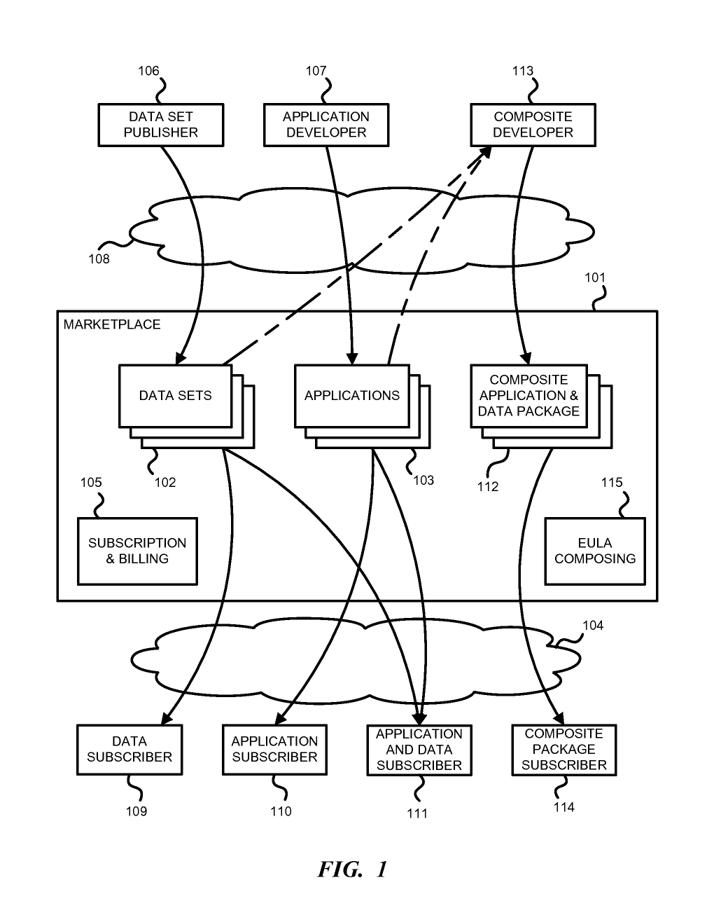

FIG. 1 is a block diagram illustrating a marketplace 101 that offers data sets and applications to users according to one embodiment. Marketplace 101 comprises a plurality of data sets 102 and applications 103 that are available for use by subscribers. Marketplace 101 may be a website hosted on a web server that is accessed by subscribers via a public or private network 104, such as an intranet or Internet. The subscribers may browse the available data sets 102 and applications 103 on marketplace 101. When a subscriber identifies useful or required content in marketplace 101, subscription and billing module 105 allows the subscriber to purchase a subscription to the selected content.

The marketplace content, such as data sets 102 and applications 103 is provided by publishers 106 and/or developers 107. The content may be uploaded to marketplace 101 by publishers 106 and/or developers 107 via a public or private network 108, such as an intranet or Internet. In one embodiment, some or all of the publishers and developers are independent from and unrelated to the operator of marketplace 101 and the subscribers. Marketplace 101 provides a centralized location for the publishers 106 and developers 107 to offer their content to potential subscribers.

Data sets 102 may either be a data compilation stored in a database or a web service that returns a response based on input. Data compilations may include, for example, telephone and address verification and validation data, sports scores and statistics, current and historical financial, business and employment data, newspaper and magazine article databases, and geographic, mapping and atlas information. Web service datasets include, for example, language translation services or location-based weather forecast. A data set publisher 106 collects, correlates, and organizes information on a selected topics, industries, locations and/or events. The data publisher 106 then makes the processed information available as a data set 102 on marketplace 101. A subscriber 109 may have an interest in or need for the information available in publisher 106's data set 102. Marketplace 101 allows a subscriber 109 to review many data sets 102 from a number of different data publishers 106 without having to identify and seek out each publisher 106 separately. Once subscriber 109 selects a data set 102, subscription and billing module 105 allows the subscriber to enter into a contract for access to the data set. Subscription and billing module 105 also handles billing to the subscriber and payment to data set publisher 106.

Data sets 102 may use a standardized protocol for querying data. By standardizing the queries to data sets 102, the data may be used without requiring subscriber 109 to learn or adopt a specialized interface for each data set 102. The standardized queries may define, for example, messages for calling in to the data set, messages for reading or using the data set response, standardized APIs, standardized data formats, and the like. In one embodiment, data sets 102 use the Open Data Protocol (OData), which exposes information from a variety of sources, such as relational databases, file systems, content management systems, and web sites, and allows a subscriber 109 to access to the data set 102 via HTTP messages. A publisher 106 may make changes to the data set 102 by directly modifying the database in which the data is stored. Publisher 106 does not have to go through an OData API to access the data set 102.

Applications 103 may include any application, such as word or data processing, mapping, scheduling, business, financial, entertainment, social media, data storage and backup, and/or other applications. An application developer 107 creates an application 103 and then makes the application available on marketplace 101. A subscriber 110 may have a need for the capabilities of application 103. Marketplace 101 allows the subscriber 110 to review many applications 103 from different application developers 107 without having to identify and seek out each developer 107 separately. Once subscriber 110 selects an application 103, subscription and billing module 105 allows the subscriber to enter into a contract for access to the application. Subscription and billing module 105 also handles billing to the subscriber and payment to the application developer 107.

In one embodiment, one or more applications 103 are designed to operate in a cloud environment in which hosted services are delivered over the Internet. Applications 103 may be sold on an on-demand basis, typically charged by the minute or the hour. Applications 103 may also be elastic so that the user can have as much or as little of a service as required at any given time. Additionally, applications 103 are typically fully managed by the vendor or developer so that the user needs nothing but a computer and Internet access. For example, subscriber 110 may use developer 107's application 103 as Software as a Service (SaaS) on the cloud without having to load, update and maintain the application. In the SaaS model, the vendor or developer supplies the hardware infrastructure, the software code, and interacts with the user through a front-end portal. The SaaS provider hosts both the application and the data and, therefore, the user is free to use the service from anywhere.

Some applications 103 may be adapted to operate on external data. A subscriber to an application 103 that requires input data needs to provide the data used by the application. For example, a mapping application may require geographical data or a business application may require interest rate or tax rate data. Some subscribers 110 will have access to the relevant data, such as from proprietary or other databases, and, therefore, only need subscribe to application 103 alone. Other subscribers 111, however, may also need to subscribe to one or more data sets 102 to be used by desired application 103. This would allow application and data subscriber 111 to use application 103, without providing or maintaining certain types of data. For example, subscriber 111 may subscribe to a shipping application 103 that requires address verification data or zip code data. Rather than providing such information itself, subscriber 111 may subscribe to the appropriate data set 102 for address verification or zip code data.

Marketplace 101 may also offer composite application and data package 112 that includes a previously associated group of applications 103 and data sets 102. A developer 113 may identify an application 103 and one or more data sets 102 that can be used together. Composite developer 113 creates a composite application and data package 112 that combines the selected application and data sets. The application and data set in the composite package 104 may be closely related, such as a mapping application and a data set of street addresses.

Alternatively, the application and data set may have no apparent relationship. For example, composite developer 113 may combine a graphing application that generates graphs, charts or other displays with a data set of sports scores to create a sports statistics application. This composite of the graphing application and sports score data set may be offered as a package 112 on marketplace 101. This creates new content that composite package subscribers 114 may use without having to create or configure combinations themselves.

Each data set 102 and application 103 in marketplace 101 is associated with a subscription fee. For example, a subscriber may be required to pay a fixed monthly fee to access a selected application or data set. Alternatively, or in addition to the fixed monthly fee, the subscriber may pay a subscription fee that is based upon the volume of user, such as a fee based upon the number of queries to a data set or based upon the number of records processed by the application. In one embodiment, subscription and billing module 105 determines the type of fee structure associated with a selected data set or application and changes the subscriber accordingly. This type of billing is appropriate for subscribers 109-111, who have identified specific applications 103 and/or data sets 102 on marketplace 101 that they want to access. Subscription and billing module 105 may bill these subscribers directly or indirectly for the use of the selected applications 103 and data sets 102.

However, this subscription and billing methodology may not be ideal for other subscribers, such as composite package subscriber 114, who wants to use composite package 112. Subscriber 114 would desire a single subscription, instead of several separate subscriptions to the underlying application and to the data sets that are part of composite package 112. For example, if the application 103 and a first data set 102 in package 112 each have a flat fee monthly subscription and a second data set 102 in the package 112 has a per-query subscription, then composite subscriber 114 would have to track three different subscriptions to use one composite package 112.

In some embodiments, subscription and billing module 105 combines individual subscriptions for the underlying data sets 102 and application 103 that are used in composite package 112 and presents subscriber 114 with a single invoice for the package. In this way, the composite developer 113 and composite subscriber 114 do not have to deal with multiple subscriptions, which may each have different terms and rates.

In one embodiment, each data set 102 and application 103 indicates whether it may be combined with other content to create a composite package 112. The data sets 102 and applications 103 may also designate one or more acceptable subscription plans that can be used in such a combination. The composite developer 113 or the subscription and billing module 105 use these designated subscription plans to generate a composite subscription for the package 112.

A data set 102 or application 103 indicates that it may be combined with other content into a composite package and designates one or more pricing models to be used. For example, the data set or application may designate one or more of the following subscription plans that may be used in pricing the composite package:
a fixed subscription fee that designates a set amount to be charged per month or other interval (e.g. $5.00 per month);
a per-use subscription fee that designates a set amount to be charged per use, calculation, or query (e.g. $0.01 per query); and
a revenue sharing subscription that designates a portion of the total composite package subscription fee to be paid to the application or data set owner (e.g. 20% of the composite package subscription fee).

It will be understood that other pricing and billing models may also be used to determine the subscription rates of the composite application and data package 112.

Subscription and billing module 105 determines the appropriate billing model to be used for a composite package 112 and bills subscriber 114 a single fee for the subscription. Subscription and billing module 105 then pays publishers and developers of the underlying data sets and applications as required under the billing model.

For example, an application developer 107 who creates an application 103 indicates that the application may be combined with other content in a composite package 112 and designates one or more pricing models to be used in determining the price of the composite package 112. A data set publisher 106 creates a data set 102, indicates that the data set may be combined with other content in a composite package 112, and designates one or more pricing models to be used in determining the price of the composite package 112. Composite developer 113 combines the application and data set into a composite package 112 and offers it for use on marketplace 101. Composite developer 113 notifies subscription and billing module 105 what pricing model to use for the composite package 112. When subscriber 114 pays the subscription fee to use the composite package 112, the subscription and billing module 105 handles distribution of the fee among the application developer and data set publishers.

The data sets 102 and applications 103 each have an associated end user license agreement (EULA) that defines the terms of use for subscribers. Data subscriber 109, application subscriber 110, and application and data subscriber 111 accept the terms of the EULA for the individual data sets 102 or applications 103 to which they subscribe. Application and data subscriber 111 is subscribed to multiple items and accepts the EULAs associated with each selected data set or application. However, a subscriber 114 to composite application and data package 112 has not selected the underlying application and data sets and, therefore, does not expect to be presented with multiple EULAs to use the composite package 112.

In some embodiments, EULA composing module 115 provides a composite EULA for an application and data set package 112. In addition to designating pricing models for composite packages, data sets 102 and applications 103 may also designate EULA provisions that are desired or required for a composite package. When a composite developer 113 creates a composite application and data set package 112, EULA composing module 115 identifies the EULA provisions required by the underlying application and data sets and combines those provisions into a single composite EULA that covers the composite package 112. Subscribers 114 are presented with this single composite EULA for acceptance when subscribing to the composite package 112.

EULA composing module 115 may use a set of rules to combine the EULA provisions from the combined data sets and application. The rules may provide guidance on how to handle conflicting EULA provisions. The rules may assist the EULA composing module 115 in determining which provisions to include in the composite EULA, such as the most restrictive or least restrictive of the conflicting provisions. For example, if two data sets are combined in a composite package 112 and each data set's EULA designates a different limit on sharing the data by third parties, the rules used by EULA composing module 115 are used to determine which provision to include in the composite EULA.

The composite EULA may be automatically generated by EULA composing module 115 and provided to interested subscribers 114. In other embodiments, data set publisher 106 and application developer 107 may review proposed composite EULAs prior to release of a composite application and data set package. The publisher and developer may approve or propose modifications to the composite EULA prior to release to interested composite package subscribers 114.

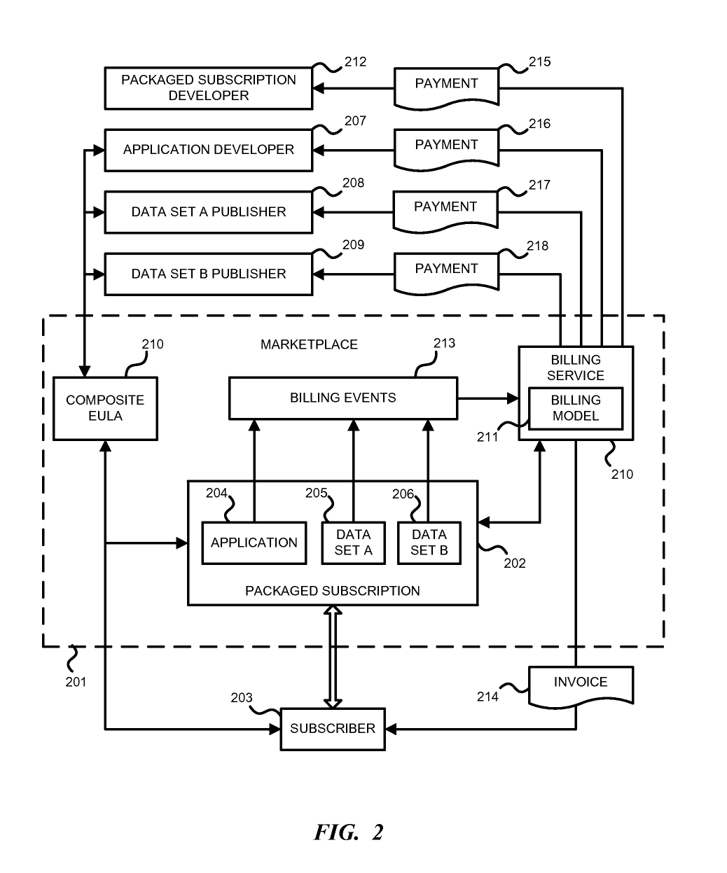

FIG. 2 is a block diagram illustrating relationships among entities associated with a packaged subscription in an application and data set marketplace 201. A packaged subscription 202 is available to subscriber 203, who may subscribe to the packed subscription 202 to access the services of application 204 combined with the data in data set A 205 and data set B 206. Application 204 is provided by application developer 207. Data sets A and B 205, 206 are provided by data set publishers 208, 209, respectively. Packaged subscription 202 may be created by subscriber 203 as a self-service composition or by application developer 207, data set A publisher 208, data set B publisher 209 or another entity.

Once subscribed to packaged subscription 202, subscriber 203 adopts composite EULA 210, which includes the EULA provisions required by application developer 207, data set A publisher 208, and data set B publisher 209. Composite EULA 210 controls the use and events allowed by packaged subscription 202 when used by subscriber 203.

Billing service 210 maintains a billing model 211 for the packed subscription 202. The billing model 211 identifies the subscription fees to be charged to subscriber 203 and other users. Billing model 211 also identifies how the subscription fees are to be distributed among application developer 207, data set A publisher 208, and data set B publisher 209. If another party 212 created the packaged subscription, then billing model 211 also identifies the portion of the subscription fee due to the packaged subscription developer 212. Using billing model 211, billing service 210 may track how much is paid by users and how much is to be paid to the developers and publishers of the packaged content.

As subscriber 203 uses the packaged subscription 201, the component application 204 and data sets 205, 206 generate billing events 213. Billing service 210 collects information on billing events 213 and applies billing model 211 to generate an invoice 214 for subscriber 203. Billing events 213 and billing model 211 are also used to generate payments 215-218, which are distributed to packaged subscription developer 212, application developer 207, data set A publisher 208, and data set B publisher 209.

Marketplace 201 or a related service may provide a provisioning service that configures the composite services and configures a runtime for the components of the packaged subscription as well as the data access of the data sources based on the composite solution model.

As noted above, OData may be used to standardize the way the applications and data sets communicate. The authentication and authorization process may also be standardized. For example, in one embodiment, OAuth (Open Authorization) may be used to share access private resources between applications, data sets, or other components. The OAuth standard allows users to hand out tokens to data hosted by various service providers. Each token grants access to a specific site for specific resources and for a defined duration. This allows a user to grant a third party site access to their information stored with another service provider, without sharing their access permissions or the full extent of their data. Using OData or another token-based authentication and authorization service, a subscriber 203 may be assigned a single token that provides access to application 204, data set A 205, data set B 206 and any other required content, modules, applications, or data.

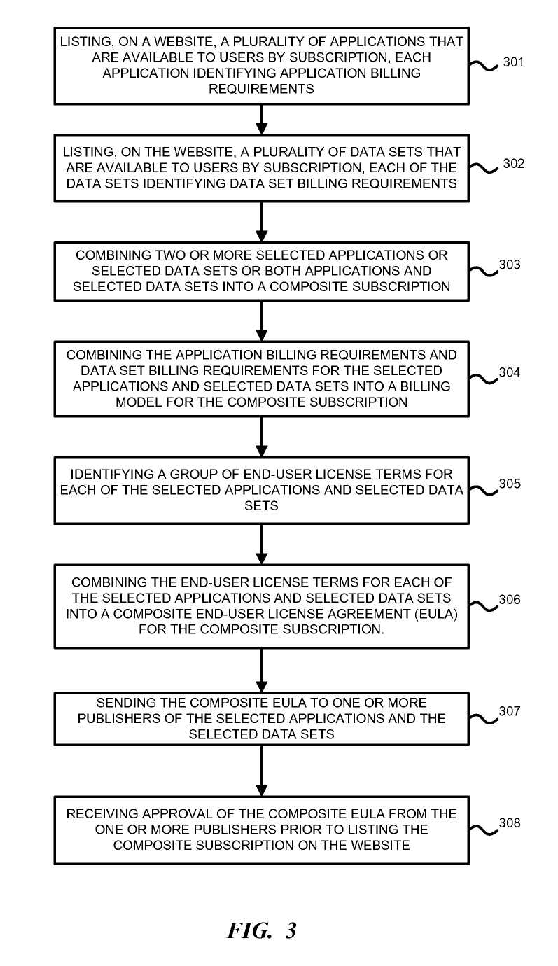

FIG. 3 is a flowchart illustrating one embodiment of a process or method for offering composite application and data subscriptions to end-users. In step 301, a plurality of applications are listed on a website. The applications are available to users by subscription. Each application identifies application billing requirements. In step 302, a plurality of data sets are listed on the website. The data sets are available to users by subscription. Each of the data sets identify data set billing requirements. In step 303, one or more selected applications and one or more selected data sets are combined into a composite subscription. In step 304, the application billing requirements and data set billing requirements for the selected applications and selected data sets are combined into a billing model for the composite subscription.

In step 305, a group of end-user license terms are identified for each of the selected applications and selected data sets. In step 306, the end-user license terms for each of the selected applications and selected data sets are combined into a composite end-user license agreement (EULA) for the composite subscription. In step 307, the composite EULA is sent to one or more publishers of the selected applications and the selected data sets for review and approval. In step 308, an approval of the composite EULA is received from the one or more publishers. The composite subscription may be listed on the website once the composite EULA is approved.

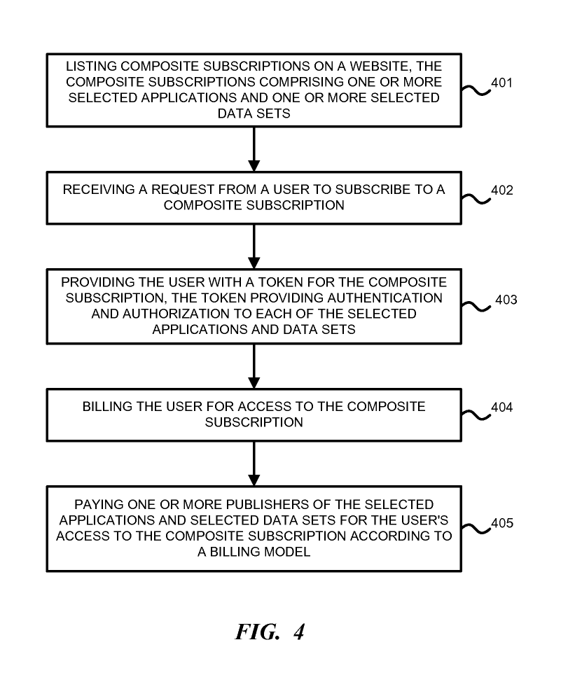

FIG. 4 is a flowchart illustrating one embodiment of a process or method for using a composite application and data subscriptions by an end-user. In step 401, composite subscriptions are listed on a website. The composite subscriptions comprise one or more selected applications and one or more selected data sets. In step 402, a request is received from a user to subscribe to a composite subscription. In step 403, the user is provided with a token for the composite subscription. The token provides authentication and authorization to each of the selected applications and data sets within the composite subscription.

In step 404, the user is billed for access to the composite subscription. In step 405, one or more publishers of the selected applications and selected data sets are paid for the user's access to the composite subscription according to a billing model. The billing model may be defined by the selected applications and data sets that comprise the composite subscription.

It will be understood that steps 301-308 of the process illustrated in FIG. 3 and steps 401-405 of the process illustrated in FIG. 4 may be executed simultaneously and/or sequentially. It will be further understood that each step may be performed in any order and may be performed once or repetitiously.

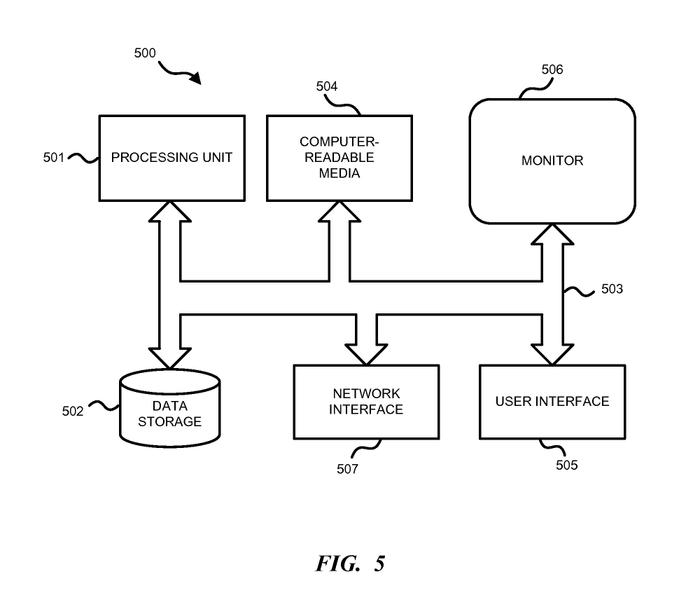

FIG. 5 illustrates an example of a suitable computing and networking environment 500 on which the examples of FIGS. 1-4 may be implemented. The computing system environment 500 is only one example of a suitable computing environment and is not intended to suggest any limitation as to the scope of use or functionality of the invention. The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an exemplary system for implementing various aspects of the invention may include a general purpose computing device in the form of a computer 500. Components may include, but are not limited to, processing unit 501, data storage 502, such as a system memory, and system bus 503 that couples various system components including the data storage 502 to the processing unit 501. The system bus 503 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 500 typically includes a variety of computer-readable media 504. Computer-readable media 504 may be any available media that can be accessed by the computer 501 and includes both volatile and nonvolatile media, and removable and non-removable media, but excludes propagated signals. By way of example, and not limitation, computer-readable media 504 may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 500. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media. Computer-readable media 504 may be offered as a computer program product.

The data storage or system memory 502 includes computer storage media in the form of volatile and/or nonvolatile memory such as read only memory (ROM) and random access memory (RAM). A basic input/output system (BIOS), containing the basic routines that help to transfer information between elements within computer 500, such as during start-up, is typically stored in ROM. RAM typically contains data and/or program modules that are immediately accessible to and/or presently being operated on by processing unit 501. By way of example, and not limitation, data storage 502 holds an operating system, application programs, and other program modules and program data.

Data storage 502 may also include other removable/non-removable, volatile/nonvolatile computer storage media. By way of example only, data storage 502 may be a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The drives and their associated computer storage media, described above and illustrated in FIG. 5, provide storage of computer-readable instructions, data structures, program modules and other data for the computer 500.

A user may enter commands and information through a user interface 505 or other input devices such as a tablet, electronic digitizer, a microphone, keyboard, and/or pointing device, commonly referred to as mouse, trackball or touch pad. Other input devices may include a joystick, game pad, satellite dish, scanner, or the like. These and other input devices are often connected to the processing unit 501 through a user input interface 505 that is coupled to the system bus 503, but may be connected by other interface and bus structures, such as a parallel port, game port or a universal serial bus (USB). A monitor 506 or other type of display device is also connected to the system bus 503 via an interface, such as a video interface. The monitor 506 may also be integrated with a touch-screen panel or the like. Note that the monitor and/or touch screen panel can be physically coupled to a housing in which the computing device 500 is incorporated, such as in a tablet-type personal computer. In addition, computers such as the computing device 500 may also include other peripheral output devices such as speakers and printer, which may be connected through an output peripheral interface or the like.

The computer 500 may operate in a networked environment using logical connections 507 to one or more remote computers, such as a remote computer. The remote computer may be a personal computer, a server, a router, a network PC, a peer device or other common network node, and typically includes many or all of the elements described above relative to the computer 500. The logical connections depicted in FIG. 5 include one or more local area networks (LAN) and one or more wide area networks (WAN), but may also include other networks. Such networking environments are commonplace in offices, enterprise-wide computer networks, intranets and the Internet.

When used in a LAN networking environment, the computer 500 may be connected to a LAN through a network interface or adapter 507. When used in a WAN networking environment, the computer 500 typically includes a modem or other means for establishing communications over the WAN, such as the Internet. The modem, which may be internal or external, may be connected to the system bus 503 via the network interface 507 or other appropriate mechanism. A wireless networking component such as comprising an interface and antenna may be coupled through a suitable device such as an access point or peer computer to a WAN or LAN. In a networked environment, program modules depicted relative to the computer 500, or portions thereof, may be stored in the remote memory storage device. It may be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
listing, on a website, a plurality of applications that are available to users by subscription, each application identifying application billing requirements;
listing, on the website, a plurality of data sets that are available to users by subscription, each of the data sets identifying data set billing requirements;
combining two or more selected applications or selected data sets or both applications and selected data sets into a composite subscription; and
combining the application billing requirements and data set billing requirements for the selected applications and selected data sets into a billing model for the composite subscription.

2. The method of claim 1, further comprising:
listing the composite subscription on the website.

3. The method of claim 1, further comprising:
receiving a request from a user to subscribe to the composite subscription;
providing the user with a token for the composite subscription, the token providing authentication and authorization to each of the selected applications and data sets.

4. The method of claim 1, further comprising:
identifying a group of end-user license terms for each of the selected applications and selected data sets; and
combining the end-user license terms for each of the selected applications and selected data sets into a composite end-user license agreement (EULA) for the composite subscription.

5. The method of claim 4, further comprising:
if a publisher of the composite subscription determines that EULA approval is required, then
sending the composite EULA to one or more publishers of the selected applications and the selected data sets; and
receiving approval of the composite EULA from the one or more publishers prior to listing the composite subscription on the website.

6. The method of claim 1, further comprising:
billing a user for access to the composite subscription; and
paying one or more publishers of the selected applications and selected data sets for the user's access to the composite subscription according to the billing model.

7. The method of claim 1, further comprising:
provisioning the composite subscription; and
configuring a runtime for the selected application and selected data sets.

8. A system, comprising:
one or more processors;
system memory;
one or more computer-readable storage media having stored thereon computer-executable instructions that, when executed by the one or more processors, causes the processors to perform a method for providing composite application and data subscriptions, the processor operating to:
provide a marketplace to users, the marketplace offering subscriptions to applications and data sets;
create a composite application and data subscription by combining one or more selected applications and one or more selected data sets; and
offering the composite application and data subscription to end-users.

9. The system of claim 8, wherein the processor further operates to:
provision the composite application and data subscription; and
configure a runtime for the selected application and data sets.

10. The system of claim 8, wherein:
each of the applications and data sets identifying billing options for use when combined with other content;
wherein the processor further operates to:
create a billing model for the composite application and data subscription.

11. The system of claim 10, wherein the processor further operates to:
collect billing events from the composite application and data subscription;
apply the billing model to the billing events; and
generate payments to publishers of the selected applications and selected data sets.

12. The system of claim 8, wherein the processor further operates to:
receive a request from a user to subscribe to the composite application and data subscription;
provide the user with a token for the composite application and data subscription, the token providing authentication and authorization to each of the selected applications and data sets.

13. The system of claim 8, wherein the processor further operates to:
identify a group of end-user license terms for each of the selected applications and selected data sets; and
combine the end-user license terms for each of the selected applications and selected data sets into a composite end-user license agreement (EULA) for the composite subscription.

14. The system of claim 13, wherein the processor further operates to:
transmit the composite EULA to one or more publishers of the selected applications and the selected data sets; and
receive approval of the composite EULA from the one or more publishers prior to offering the composite subscription to end-users.

15. A computer program product for implementing a method for providing packaged subscriptions to end-users, the computer program product comprising one or more computer-readable storage media having stored thereon computer-executable instructions that, when executed by one or more processors of a computing system, cause the computing system to perform the method comprising of:
providing a marketplace to users, the marketplace offering subscriptions to applications and data sets;
creating a packaged subscription by combining one or more selected applications and one or more selected data sets; and
offering the packaged subscription to end-users.

16. The computer program product of claim 15, further comprising:
provision the packaged subscription; and
configure a runtime for the selected application and data sets.

17. The computer program product of claim 15, further comprising:
collecting billing events from the packaged subscription;
applying a billing model to the billing events; and
generating payments to publishers of the selected applications and selected data sets.

18. The computer program product of claim 15, further comprising:
receiving a request from a user to subscribe to the packaged subscription; and
providing the user with a token for the packaged subscription, the token providing authentication and authorization to each of the selected applications and data sets.

19. The computer program product of claim 15, further comprising:
identifying a group of end-user license terms for each of the selected applications and selected data sets; and
combine the end-user license terms for each of the selected applications and selected data sets into a composite end-user license agreement (EULA) for the packaged subscription.

20. The computer program product of claim 15, further comprising:
transmit the composite EULA to one or more publishers of the selected applications and the selected data sets; and
receiving approval of the composite EULA from the one or more publishers prior to offering the packaged subscription to end-users.
